(19) United States
(12) Patent Application Publication
(10) Pub. No.: US 2019/0094647 A1
(43) Pub. Date: Mar. 28, 2019

(54) OPTICAL MODULATION APPARATUS

(71) Applicant: SUMITOMO ELECTRIC INDUSTRIES, LTD., Osaka (JP)

(72) Inventors: Taizo TATSUMI, Osaka (JP); Akira Furuya, Osaka (JP)

(73) Assignee: SUMITOMO ELECTRIC INDUSTRIES, LTD., Osaka (JP)

(21) Appl. No.: 16/143,007

(22) Filed: Sep. 26, 2018

(30) Foreign Application Priority Data
Sep. 27, 2017 (JP) 2017-186625

(51) Int. Cl. G02F 1/225

(52) U.S. Cl. CPC G02F 1/2255; G02F 2001/212

(57) ABSTRACT

The apparatus includes: an electric circuit including a first transmission line portion that propagates a second differential signal; a second amplifier that amplifies the second differential signal propagated through the first transmission line portion and outputs the amplified second differential signal as a third differential signal; a second transmission line portion that propagates the third differential signal; and an optical modulator including a first optical phase modulation portion that modulates a phase of an optical signal in response to the second differential signal propagating the first transmission line portion, an optical delay portion that delays the phase of the optical signal modulated, and a second optical phase modulation portion that modulates the phase of the optical signal delayed, in response to the third differential signal. The second amplifier has a gain that has a maximum value in a first frequency region of the second differential signal set to be smaller than a minimum value in a second frequency region higher in frequency than the first frequency region.

### TECHNICAL FIELD

Exemplary embodiments according to an aspect of the present invention relate to an optical modulation apparatus.

### BACKGROUND

U.S. Patent Application Publication No. 2003/0227666 discloses a technique related to a method for driving an optical modulator. In this technique, modulation signals are propagated to respective electrodes of an optical modulator throught transmission lines whose lengths differ from each other, and reach the electrodes in synchronization with the propagation of an optical signal. U.S. Patent Application Publication No. 2007/0237444 discloses a technique for supressing propagation delay variations related to a driver circuit of a Mach-Zehnder optical modulator. U.S. Patent Application Publication No. 2012/0315036 discloses a technique for generating a pulse amplitude modulation signal in a Mach-Zehnder optical modulator. When a modulation signal is propagated to a transmission line electrode formed on an optical waveguide of an optical modulator, if a delay circuit is used for phase adjustment to an optical signal, the mounting area of an electric circuit board is increased. Such increasing of the mounting area of an electric circuit board hinders downsizing of an optical modulation apparatus.

### SUMMARY

An optical modulation apparatus according to an aspect of the present invention is an optical modulation apparatus configured to modulate an optical signal in response to a differential input signal, and the optical modulation apparatus includes an electric circuit and an optical modulator. The electrical circuit includes: an input circuit configured to generate a first differential signal in response to the differential input signal; a first amplifier configured to amplify the first differential signal, and output an amplified first differential signal as a second differential signal; a first transmission line portion configured to propagate the second differential signal; a second amplifier configured to amplify the second differential signal output from the first transmission line portion, and output an amplified second differential signal as a third differential signal; a second transmission line portion configured to propagate the third differential signal; and a termination circuit configured to terminate the third differential signal propagated through the second transmission line portion. The optical modulator includes a first optical modulation portion configured to modulate a phase of the optical signal in response to the second differential signal propagating through the first transmission line portion, an optical delay portion configured to delay the phase of the optical signal modulated by the first optical phase portion by a first delay time, and a second optical modulation portion configured to modulate the phase of the optical signal modulated by the first optical modulation portion and delayed by the optical delay portion, in response to the third differential signal propagating through the second transmission line portion. The second amplifier has a gain that has a maximum value in a first frequency region of the second differential signal set to be smaller than a minimum value in a second frequency region higher in frequency than the first frequency region.

### BRIEF DESCRIPTION OF THE DRAWINGS

FIG. 1 is a diagram illustrating a configuration of an electric circuit board of an optical modulation apparatus according to an exemplary embodiment;

FIG. 2 is a diagram illustrating a configuration of an optical waveguide board of the optical modulation apparatus according to the exemplary embodiment;

FIG. 3 is a circuit diagram of a first stage amplifier of the electric circuit board illustrated in FIG. 1;

FIG. 4 is a circuit diagram of a second stage amplifier of the electric circuit board illustrated in FIG. 1;

FIG. 5 is a circuit diagram of a third stage amplifier of the electric circuit board illustrated in FIG. 1;

FIG. 6 is a circuit diagram of a fourth stage amplifier of the electric circuit board illustrated in FIG. 1;

FIG. 7 is a circuit diagram of a termination circuit of the electric circuit board illustrated in FIG. 1;

FIG. 8 is a formula group for explaining operation of the third stage amplifier illustrated in FIG. 5;

FIG. 9 is a diagram illustrating a frequency characteristic of the third stage amplifier illustrated in FIG. 5; and

FIG. 10 is a diagram illustrating change of an amplitude of a modulation signal flowing through an electric circuit of the optical modulation apparatus according to the exemplary embodiment.

### DETAILED DESCRIPTION

Specific examples of an optical modulation apparatus according to an exemplary embodiment will be described below with reference to the drawings. Note that, the present invention is not limited to these exemplifications, and it is intended that all modifications are included indicated by the claims and within the scope and meaning equivalent to the claims. In the description of the drawings in the following explanation, the same elements will be denoted by the same reference signs, and duplicate descriptions will be omitted.

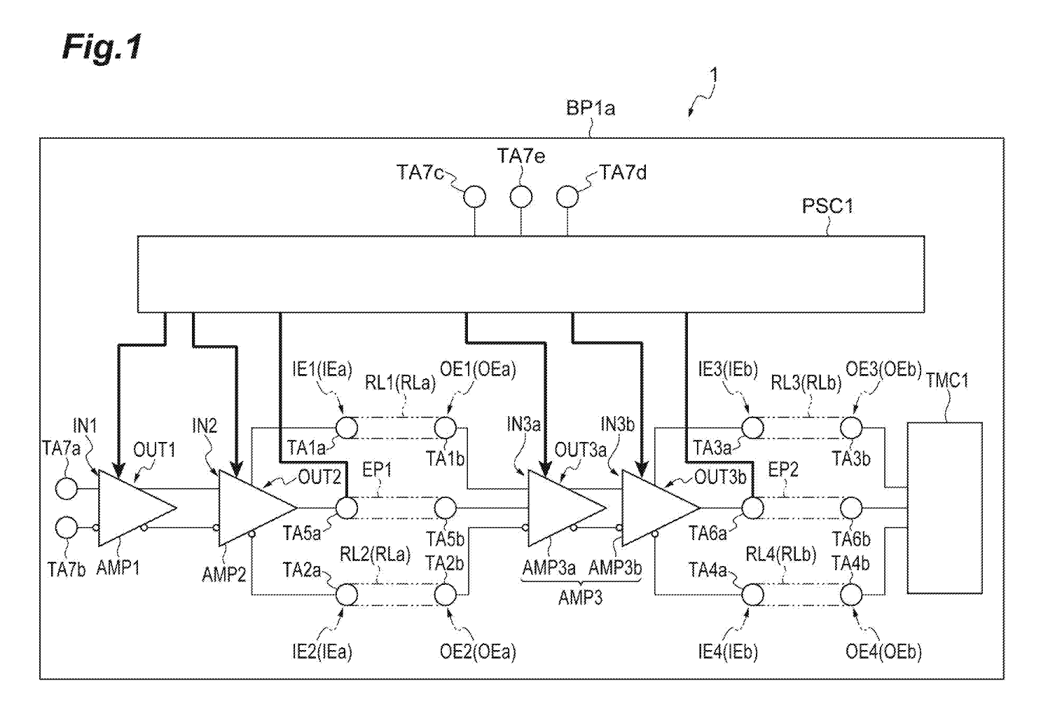

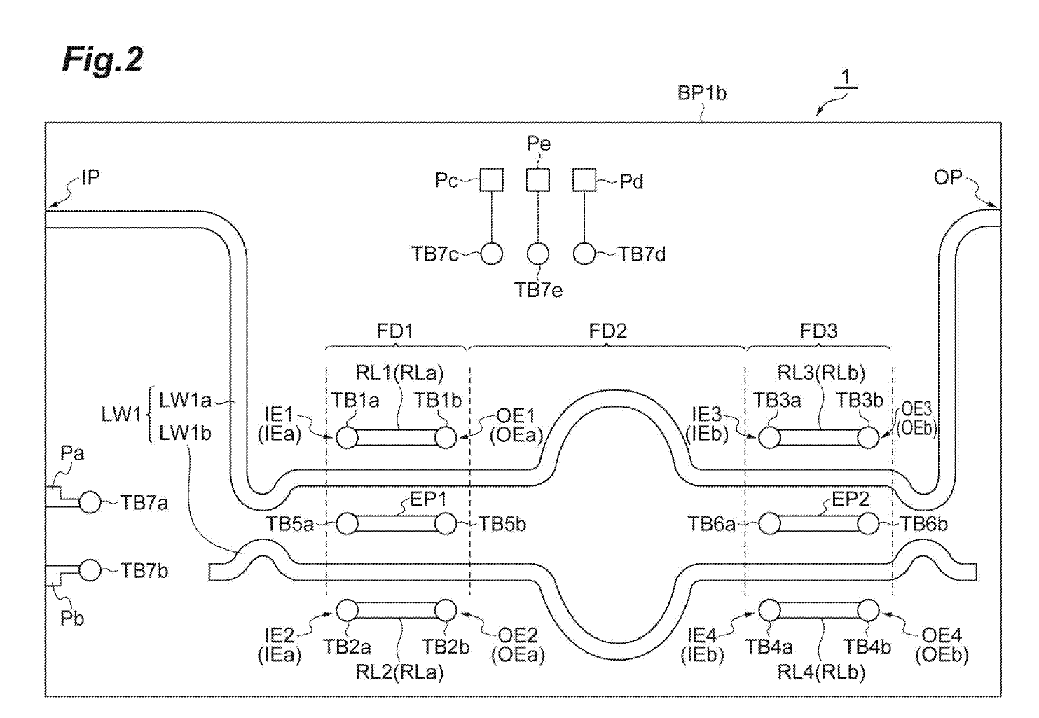

First, with reference to FIGS. 1 and 2, a configuration will be described of an optical modulation apparatus 1 according to the exemplary embodiment. FIG. 1 is a diagram illustrating a configuration of an electric circuit board of the optical modulation apparatus according to the exemplary embodiment. FIG. 2 is a diagram illustrating a configuration of an optical waveguide board of the optical modulation apparatus according to the exemplary embodiment.

The optical modulation apparatus 1 is an optical modulation apparatus including a Mach-Zehnder optical modulator configured to modulate an optical signal in response to a differential modulation signal. The optical modulation apparatus 1 includes an electric circuit board BP1a illustrated in FIG. 1 and an optical waveguide board BP1b illustrated in FIG. 2. The electric circuit board BP1a is provided on the optical waveguide board BP1b. The electric circuit board BP1a and the optical waveguide board BP1b are electrically connected to each other. The electrical connection will be described in detail later.

The electric circuit board BP1a includes: amplifiers AMP1 (input circuit), AMP2 (first amplifier), and AMP3; a power supply circuit PSC1; and a termination circuit TMC1. The amplifier AMP3 includes amplifiers AMP3a (second amplifier) and AMP3b. The electric circuit board BP1a further includes terminals TA1a to TA7e. The electric circuit board BP1 includes a portion (first portion) of an electric circuit. The portion of the electrical circuit includes the amplifiers AMP1, AMP2, and AMP3 and the termination circuit TMC1.

The optical waveguide board BP1b includes: transmission line portions RLa (first transmission line portion) and RLb (second transmission line portion) through which an electric signal (differential modulation signal) propagates; and an optical waveguide portion LW1 through which an optical signal propagates. The amplifiers AMP1 to AMP3 provided on the electric circuit board BP1a and the transmission line portions RLa and RLb provided on the optical waveguide board BP1b are included in an electric circuit of the optical modulation apparatus 1 (an electric circuit through which the differential modulation signal propagates in the optical modulation apparatus 1). The optical waveguide board BP1b further includes: electrode pads Pa and Pb; terminals TB1a to TB7e; and electrode pads Pc to Pe. The optical waveguide board BP1b further includes electrodes EP1 and EP2. The electrodes EP1 and EP2 may be included in the transmission line portions RLa and RLb, respectively. The electrodes RLa and RLb constitute another portion (second portion) of the electric circuit. Therefore, the electric circuit of the optical modulation apparatus 1 includes the amplifiers AMP1, AMP2, and AMP3, and the termination circuit TMC1, which are formed on the electric circuit board BP1a, and the transmission line portions RLa and RLb, which are formed on optical waveguide board BP1b.

The transmission line portion RLa includes an input end portion IEa and an output end portion OEa. The transmission line portion RLb includes an input end portion IEb and an output end portion OEb. The transmission line portion RLa includes transmission line electrodes RL1 and RL2. The transmission line electrodes RL1 and RL2 are electrodes each forming a transmission line having characteristic impedance. The transmission line portion RLb includes transmission line electrodes RL3 and RL4. The transmission line electrodes RL3 and RL4 are electrodes each forming a transmission line having characteristic impedance. The transmission line electrode RL1 includes an input end TE1 and an output end OE1. The transmission line electrode RL2 includes an input end IE2 and an output end OE2. The transmission line electrode RL3 includes an input end IE3 and an output end OE3. The transmission line electrode RL4 includes an input end IE4 and an output end OE4. The input end portion IEa of the transmission line portion RLa includes the input ends TE1 and IE2. The output end portion OEa of the transmission line portion RLa includes the output ends OE1 and OE2. A differential signal can be propagated from the input ends IE1 and IE2 to the output ends OE1 and OE2. The input end portion IEb of the transmission line portion RLb includes the input ends IE3 and IE4. The output end portion OEb of the transmission line portion RLb includes the output ends OE3 and OE4. A differential signal can be propagated from the input ends IE3 and IE4 to the output ends OE3 and OE4.

The amplifier AMP1 includes an input portion IN1 and an output portion OUT1. The amplifier AMP2 includes an input portion IN2 (first input portion) and an output portion OUT2 (first output portion). The amplifier AMP3a includes an input portion IN3a and an output portion OUT3a. The amplifier AMP3b includes an input portion IN3b and an output portion OUT3b. The input portion IN3a of the amplifier AMP3a is an input portion (second input portion) of the amplifier AMP3, and the output portion OUT3b of the amplifier AMP3b is an output portion (second output portion) of the amplifier AMP3.

Each of the amplifiers AMP1 to AMP3b is an amplifier configured to amplify the differential signal. The amplifier AMP1 works as a first stage amplifier in the electric circuit of the optical modulation apparatus 1. The amplifier AMP1 generates a first differential signal in response to a differential input signal. More specifically, the amplifier AMP1 is an input buffer (input circuit), and is, for example, a differential amplifier circuit including termination resistors at the input portion IN1. The differential modulation signal (differential input signal) is externally transmitted to the input portion IN1 via a pair of signal lines (for example, a signal line for the positive phase component and another signal line for the negative phase component). The termination resistors are electrically connected to the signal lines, respectively. Each signal line includes a transmission line. A resistance value of the termination resistor may be set to, for example, 25 [Ω] to 60 [Ω] to match a characteristic impedance of the transmission line to which the termination resistor is electrically connected. For example, a typical resistance value of the termination resistor is 50 [Ω]. The amplifier AMP1 amplifies the differential input signal received by the input portion IN1 and outputs the amplified differential input signal as the first differential signal from the output portion OUT1. A differential amplitude (potential difference between the positive phase component and the negative phase component) of the first differential signal is larger than a differential amplitude of the differential input signal. In addition, a ratio of the differential amplitude of the first differential signal to the differential amplitude of the differential input signal is a differential gain of the amplifier AMP1.

The amplifier AMP2 works as a second stage amplifier in the electric circuit of the optical modulation apparatus 1. The amplifier AMP2 amplifies the first differential signal, and inputs the amplified first differential signal as a second differential signal to the transmission line portion RLa. More specifically, the amplifier AMP2 amplifies the first differential signal input to the input portion IN2, and outputs the amplified first differential signal as the second differential signal from the output portion OUT2 to the transmission line portion RLa (transmission line electrodes RL1 and RL2). The amplifier AMP2 is, for example, a differential amplifier circuit. The amplifier AMP2 is a drive buffer of the optical modulation apparatus 1, and outputs a voltage amplitude (for example, 0.8 [Vpp] to 2.5 [Vpp] per single phase) for driving a first region FD1 of the optical waveguide portion LW1 described later. A differential amplitude (potential difference between the positive phase component and the negative phase component) of the second differential signal output from the amplifier AMP2 is larger than the differential amplitude of the first differential signal input to the amplifier AMP2.

The amplifier AMP3 amplifies the second differential signal input from the amplifier AMP2 to the input portion IN3a via the transmission line portion RLa, and outputs the amplified second differential signal as a third differential signal from the output portion OUT3b to the transmission line portion RLb. As for a gain of the amplifier AMP3 (more specifically, a gain of the amplifier AMP3a) to the second differential signal, the high frequency component (second frequency region) is larger than the low frequency component (first frequency region) of the second differential signal. As described above, for example, in the gain when the amplifier AMP3a amplifies the second differential signal to the third differential signal, the maximum value in the first frequency region of the second differential signal is set to be smaller than the minimum value in the second frequency region higher in frequency than the first frequency region.

The amplifier AMP3a on the input side of the amplifier AMP3 works as a third stage amplifier in the electric circuit of the optical modulation apparatus 1. More specifically, the amplifier AMP3a is an equalizer buffer, and has a function of equalizing the differential modulation signal degraded (attenuated) by transmitting through the first region FD1 of the optical waveguide portion LW1.

The amplifier AMP3b on the output side of the amplifier AMP3 functions as a fourth stage amplifier in the electric circuit of the optical modulation apparatus 1. The amplifier AMP3b has a function similar to the function of the amplifier AMP2. More specifically, the amplifier AMP3b amplifies the differential modulation signal input from the output portion OUT3a of the amplifier AMP3a to the input portion IN3b, and outputs the amplified differential modulation signal as the third differential signal from the output portion OUT3b to the transmission line portion RLb (transmission line electrodes RL3 and RL4). The amplifier AMP3b is a drive buffer of the optical modulation apparatus 1, and outputs a voltage amplitude (for example, 0.8 [Vpp] to 2.5 [Vpp] per single phase) for driving a third region FD3 of the optical waveguide portion LW1 described later. The amplifiers AMP3a and AMP3b are electrically connected in cascade in this order from the input portion IN3a to the output portion OUT3b of the amplifier AMP3. A differential amplitude of the third differential signal output from the amplifier AMP3 is larger than the differential amplitude of the second differential signal input to the amplifier AMP3.

The input portion IN1 of the amplifier AMP1 is electrically connected to the electrode pads Pa and Pb of the optical waveguide board BP1b. Note that, this connection is made via electrical connection between the terminal TA7a of the electric circuit board BP1a and the terminal TB7a of the optical waveguide board BP1b as described later. The electrode pads Pa and Pb are electrically connected to an external circuit (for example, transmission lines) by wire bonding, for example. The optical modulation apparatus 1 receives the differential modulation signal (differential input signal) from the outside to the electrode pads Pa and Pb. The input portion IN2 of the amplifier AMP2 is electrically connected to the output portion OUT1 of the amplifier AMP1. The output portion OUT2 of the amplifier AMP2 is electrically connected to the input end portion IEa of the transmission line portion RLa. The input portion IN3a of the amplifier AMP3a is electrically connected to the output end portion OEa of the transmission line portion RLa. The input portion IN3a of the amplifier AMP3a is electrically connected to the output portion OUT2 of the amplifier AMP2 via the transmission line portion RLa. Note that, as described later, this connection is made via electrical connection between the terminals TA1a and TB1a, electrical connection between the terminals TA1b and TB1b, electrical connection between the terminals TA2a and TB2a, and electrical connection between the terminals TA2b and TB2b.

The output portion OUT3a of the amplifier AMP3a is electrically connected to the input portion IN3b of the amplifier AMP3b. The output portion OUT3b of the amplifier AMP3b is electrically connected to the input end portion IEb of the transmission line portion RLb. The termination circuit TMC1 is electrically connected to the output end portion OEb of the transmission line portion RLb. The termination circuit TMC1 is electrically connected to the output portion OUT3b of the amplifier AMP3b via the transmission line portion RLb. Note that, as described later, this connection is made via electrical connection between the terminals TA3a and TB3a, electrical connection between the terminals TA3b and TB3b, electrical connection between the terminals TA4a and TB4a, and electrical connection between the terminals TA4b and TB4b.

The configuration of an optical waveguide of the optical modulation apparatus 1 will be described in more detail. The optical waveguide portion LW1 includes an optical input end portion IP and an optical output end portion OP. The optical waveguide portion LW1 includes optical waveguides LW1a and LW1b between the optical input end portion IP and the optical output end portion OP. The optical waveguides LW1a and LW1b are arranged in parallel in the optical waveguide board BP1b such that light propagation directions in the respective optical waveguides LW1a and LW1b are parallel to each other. The optical waveguide LW1a reaches from the optical input end portion IP to the optical output end portion OP. That is, the optical waveguide LW1a includes the optical input end portion IP at one end, and the optical output end portion OP at the other end. The optical waveguide portion LW1 (optical waveguides LW1a and LW1b) includes the first region FD1, a second region FD2, and the third region FD3. The first region FD1, the second region FD2, and the third region FD3 are arranged in series in this order from the optical input end portion IP toward the optical output end portion OP. The optical waveguides LW1a and LW1b come close to each other to form a directional coupler (first directional coupler) on the optical input end portion IP side from the first region FD1. The optical signal input to the optical input end portion IP and propagating through the optical waveguide LW1a is distributed to the optical waveguides LW1a and LW1b by the directional coupler. In the first region FD1, the transmission line electrode RL1, the optical waveguide LW1a, the electrode EP1, the optical waveguide LW1b, and the transmission line electrode RL2 are arranged in parallel to each other in this order on the optical waveguide board BP1b for forming an optical modulator (first optical modulation portion).

That is, the electrode EP1 is arranged between the optical waveguides LW1a and LW1b, and with the electrode EP1 as the center, the transmission line electrode RL1 and the electrode EP1 are arranged to sandwich the optical waveguide LW1a, and the electrode EP1 and the transmission line electrode RL2 are arranged to sandwich the optical waveguide LW1b. The transmission line portion RLa includes the transmission line electrodes RL1 and RL2. The transmission line electrodes RL1 and RL2 form transmission lines, respectively. The transmission line electrodes RL1 and RL2 each have a shape in which the transmission line extends in a direction (transmission direction) of transmitting the electric signal. The transmission line electrodes RL1 and RL2 are arranged along the optical waveguide portion LW1 (optical waveguides LW1a and LW1b) in the first region FD1 together with the electrode EP1. For example, in the first region FD1, arrangement is made such that the transmission direction of the transmission line electrodes RL1 and RL2, and the optical signal propagation direction of the optical waveguides LW1a and LW1b are parallel to each other. Note that, the electrode EP1 has a shape extending in the transmission direction of the transmission line electrodes RL1 and RL2. In the first region FD1, a difference (first phase difference) between a phase of an optical signal (first optical signal) propagating through the optical waveguide LW1a and a phase of an optical signal (second optical signal) propagating through the optical waveguide LW1b increases or decreases depending on a voltage difference between one component (for example, the positive phase component) of the second differential signal propagating through the transmission line electrode RL1 and the other component (for example, the negative phase component) of the second differential signal. As described above, the first region FD1 forms a Mach-Zehnder optical modulator (first optical modulation portion) configured to modulate the phase difference of the optical signal in response to the second differential signal. The first optical modulation portion increases or decreases (modulates) the phase of the optical signal propagating through the optical waveguide portion LW1 in response to the second differential signal propagating through the transmission line portion RLa.

In the second region FD2, the optical waveguides LW1a and LW1b are arranged in parallel as in the first region FD1. In the third region FD3, the transmission line electrode RL3, the optical waveguide LW1a, the electrode EP2, the optical waveguide LW1b, and the transmission line electrode RL4 are arranged in parallel to each other in this order on the optical waveguide board BP1b for forming another optical modulator (second optical modulation portion). That is, the electrode EP2 is arranged between the optical waveguides LW1a and LW1b, and with the electrode EP2 as the center, the transmission line electrode RL3 and the electrode EP2 are arranged to sandwich the optical waveguide LW1a, and the electrode EP2 and the transmission line electrode RL4 are arranged to sandwich the optical waveguide LW1b. The transmission line portion RLb includes the transmission line electrodes RL3 and RL4. The transmission line electrodes RL3 and RL4 form transmission lines, respectively. The transmission line electrodes RL3 and RL4 each have a shape in which the transmission line extends in a direction (transmission direction) of transmitting the electric signal. The transmission line electrodes RL3 and RL4 are arranged along the optical waveguide portion LW1 (optical waveguides LW1a and LW1b) in the third region FD3 together with the electrode EP2. For example, in the third region FD3, arrangement is made such that the transmission direction of the transmission line electrodes RL3 and RL4, and the optical signal propagation direction of the optical waveguides LW1a and LW1b are parallel to each other. Note that, the electrode EP2 has a shape extending in the transmission direction of the transmission line electrodes RL3 and RL4.

In the third region FD3, a difference (second phase difference) between a phase of an optical signal (third optical signal) propagating through the optical waveguide LW1a and a phase of an optical signal (fourth optical signal) propagating through the optical waveguide LW1b increases or decreases depending on a voltage difference between one component (for example, the positive phase component) of the third differential signal propagating through the transmission line electrode RL3 and the other component (for example, the negative phase component) of the third differential signal. As described above, the third region FD3 forms a Mach-Zehnder optical modulator (second optical modulation portion) configured to modulate the phase difference of the optical signal in response to the third differential signal. The second optical modulation portion modulates the phase of the optical signal modulated by the first optical modulation portion and delayed by the second region FD2 (an optical delay portion described later), in response to the third differential signal propagating through the transmission line portion RLb. The optical waveguides LW1a and LW1b come close to each other to form a directional coupler (second directional coupler) on the optical output end portion OP side from the third region FD3. The optical signal propagating through the optical waveguide LW1a in the third region FD3 and the optical signal propagating through the optical waveguide LW1b are coupled together by the directional coupler.

The length (propagation length) of the optical waveguide portion LW1 in the second region FD2 is set to cause a time (first delay time) required from when the optical signal traveling through the optical waveguide portion LW1 is output from the first region FD1 to when the optical signal is input to the third region FD3 via the second region FD2 to match (substantially coincide with) a time (second delay time) required from a time (first time) when the second differential signal is input to the second amplifier to a time (second time) when the third differential signal is output from the second amplifier. As described above, the optical waveguide portion LW1 forms the optical delay portion in the second region FD2. The optical delay portion of the second region FD2 delays the phase of the optical signal modulated by the first optical modulation portion by the first delay time. The length of the second region FD2 is set to cause the amplifier AMP3 arranged on the electric circuit board BP1a to be located in a region between the first region FD1 and the third region FD3 on the optical waveguide board BP1b.

The length of the optical waveguide LW1a in the second region FD2 is the same as the length of the optical waveguide LW1b in the second region FD2. This length is the length along each optical waveguide, and the optical waveguides LW1a and LW1b are not only linear but may also be curved, for example, in an arc shape. The optical waveguides LW1a and LW1b in the second region FD2 may have an arc shape symmetrical to each other for a virtual centerline between the optical waveguides LW1a and LW1b. The length of the optical waveguide portion LW1 in the second region FD2 is identical to the length of the optical waveguide LW1a in the second region FD2 and also identical to the length of the optical waveguide LW1b in the second region FD2. Therefore, adjusting the length of the optical waveguide portion LW1 of the second region FD2 allows the timing at which the optical signal propagates to the optical waveguide portion LW1 of the third region FD3 to match the timing at which the differential modulation signal propagates to the transmission line portion RLb parallel to the optical waveguide portion LW1 of the third region FD3. For example, as described above, in a case where the length of the second region FD2 is determined depending on the size (occupied area) of the amplifier AMP3, causing shapes of the optical waveguides LW1a and LW1b to curve to increase the length of the optical waveguide portion LW1 allows the first delay time during which the optical signal propagates through the optical waveguide portion LW1 to match the second delay time until the third differential signal is generated from the second differential signal by the amplifier AMP3.

The configuration of the electric circuit of the optical modulation apparatus 1 will be described in more detail. The differential modulation signal (differential input signal) has the positive phase component and the negative phase component. The amplitude of the positive phase component and the amplitude of the negative phase component are substantially the same, and the phase of the positive phase component is opposite to the phase of the negative phase component. The positive phase component and the negative phase component have the same average value. The positive phase component and the negative phase component a pair of complimentary signals.

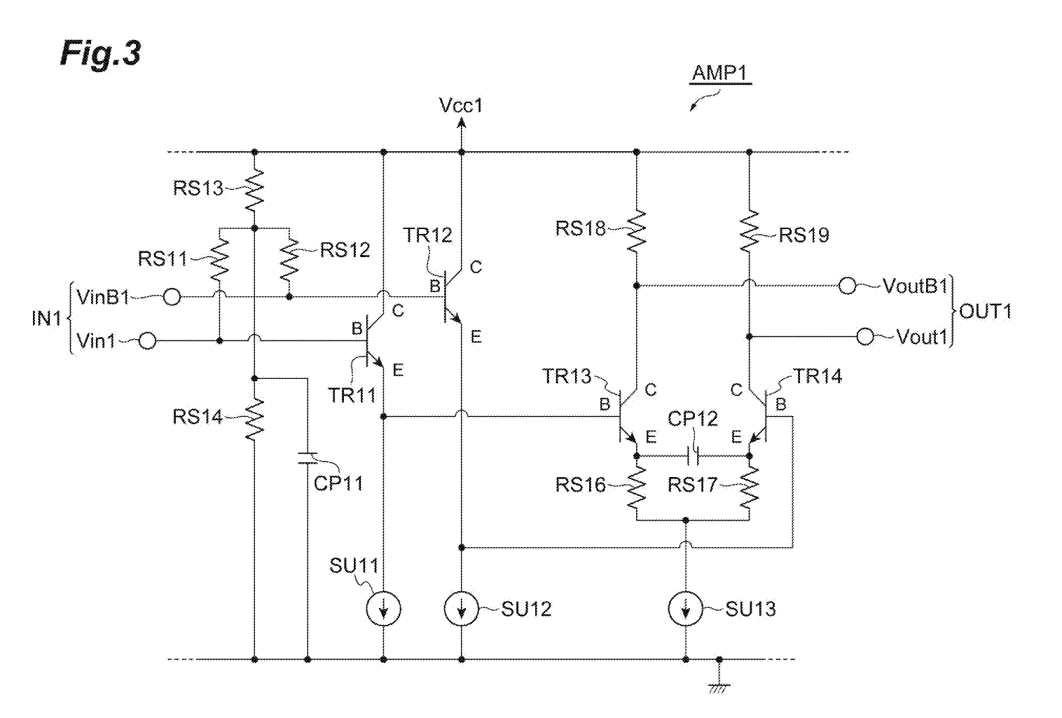

The electrode pad Pa to which the positive phase component of the differential modulation signal is input is electrically connected to the terminal TB7a, and the terminal TB7a is electrically connected (for example, bump-connected) to the terminal TA7a. The terminal TA7a is electrically connected to a positive phase terminal (an input terminal Vin1 illustrated in FIG. 3) of the input portion IN1 of the amplifier AMP1. The electrode pad Pb to which the negative phase component of the differential modulation signal is input is electrically connected to the terminal TB7b, and the terminal TB7b is electrically connected (for example, bump-connected) to the terminal TA7b. The terminal TA7b is electrically connected to a negative phase terminal (an input terminal VinB1 illustrated in FIG. 3) of the input portion IN1 of the amplifier AMP1. More specifically, the electric circuit board BP1a and the optical waveguide board BP1b are arranged such that the terminals TB7a and TA7a face each other. In a case where the terminals TB7a and TA7a are bump-connected together, the terminals are electrically connected together by solder bumps formed on the terminals. Also for other terminals on the electric circuit board BP1a and terminals on the optical waveguide board BP1b, corresponding terminals can be electrically connected together similarly.

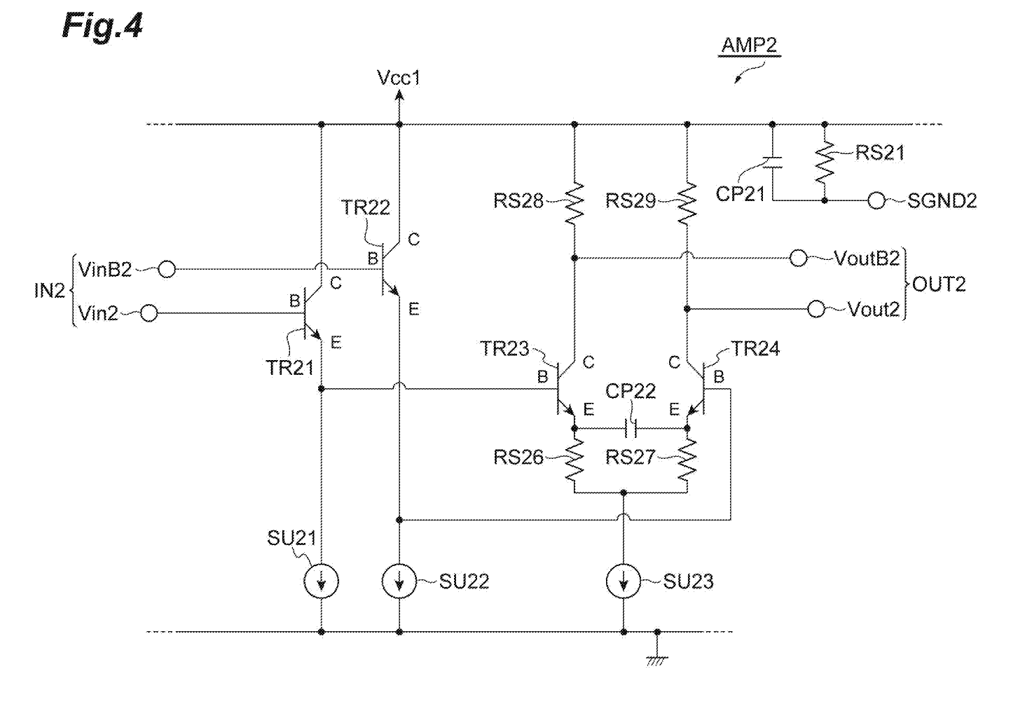

A positive phase terminal (an output terminal Vout1 illustrated in FIG. 3) of the output portion OUT1 of the amplifier AMP1 is electrically connected to a positive phase terminal (an input terminal Vin2 illustrated in FIG. 4) of the input portion IN2 of the amplifier AMP2. A negative phase terminal (an output terminal VoutB1 illustrated in FIG. 3) of the output portion OUT1 of the amplifier AMP1 is electrically connected to a negative phase terminal (an input terminal VinB2 illustrated in FIG. 4) of the input portion IN2 of the amplifier AMP2.

A positive phase terminal (an output terminal Vout2 illustrated in FIG. 4) of the output portion OUT2 of the amplifier AMP2 is electrically connected to the terminal TA1a, and the terminal TA1a is electrically connected (bump-connected) to the terminal TB1a. The terminal TB1a is electrically connected to the input end IE1 of the transmission line electrode RL1. A negative phase terminal (an output terminal VoutB2 illustrated in FIG. 4) of the output portion OUT2 of the amplifier AMP2 is electrically connected to the terminal TA2a, and the terminal TA2a is electrically connected (bump-connected) to the terminal TB2a. The terminal TB2a is electrically connected to the input end IE2 of the transmission line electrode RL2. A ground terminal (a signal ground terminal SGND2 illustrated in FIG. 4) of the amplifier AMP2 is electrically connected to the terminal TA5a, the terminal TA5a is electrically connected (bump-connected) to the terminal TB5a, and the terminal TB5a is electrically connected to the electrode EP1. As described above, with the electrode EP1 grounded in-between, the positive phase component of the second differential signal is input to the transmission line electrode RL1, and the negative phase component of the second differential signal is input to the transmission line electrode RL2.

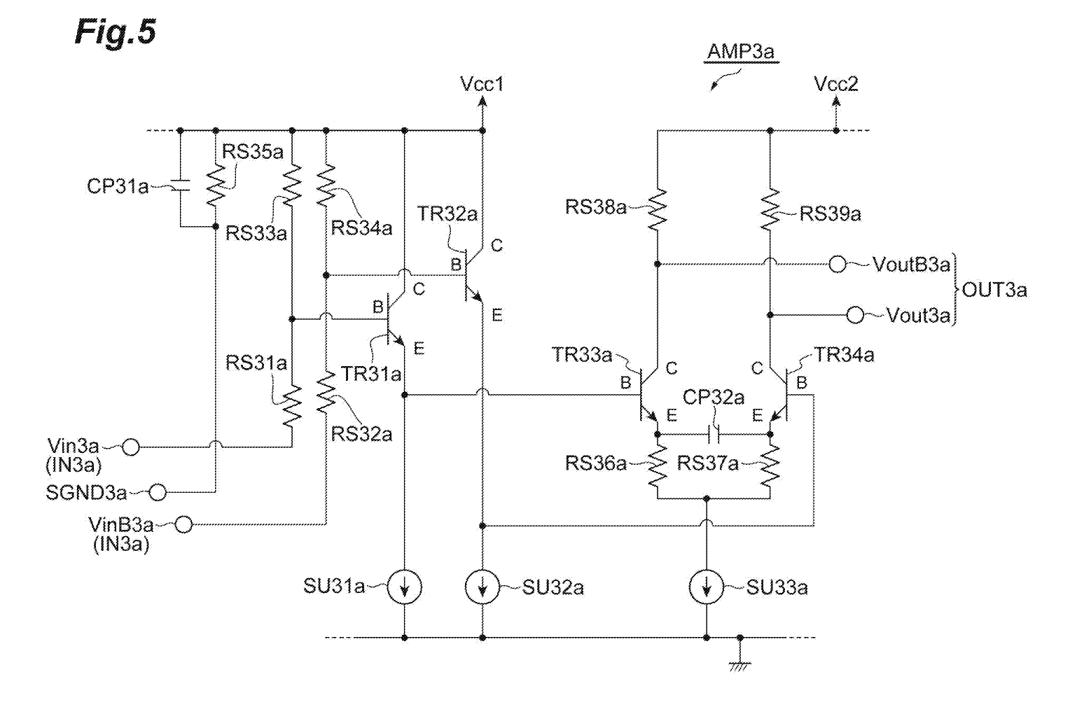

The output end OE1 of the transmission line electrode RL1 is electrically connected to the terminal TB1b, and the terminal TB1b is electrically connected (for example, bump-connected) to the terminal TA1b. The terminal TA1b is electrically connected to a positive phase terminal (an input terminal Vin3a illustrated in FIG. 5) of the input portion IN3a of the amplifier AMP3a. The output end OE2 of the transmission line electrode RL2 is electrically connected to the terminal TB2b, and the terminal TB2b is electrically connected (for example, bump-connected) to the terminal TA2b. The terminal TA2b is electrically connected to a negative phase terminal (an input terminal VinB3a illustrated in FIG. 5) of the input portion IN3a of the amplifier AMP3a. The electrode EP1 is electrically connected to the terminal TB5b, and the terminal TB5b is electrically connected (bump-connected) to the terminal TA5b. The terminal TA5b is electrically connected to a ground terminal (a signal ground terminal SGND3a illustrated in FIG. 5) of the amplifier AMP3a.

The positive phase terminal (the output terminal Vout2 illustrated in FIG. 4) of the output portion OUT2 of the amplifier AMP2 is electrically connected to the positive phase terminal (the input terminal Vin3a illustrated in FIG. 5) of the input portion IN3a of the amplifier AMP3a via the transmission line electrode RL1. The negative phase terminal (the output terminal VoutB2 illustrated in FIG. 4) of the output portion OUT2 of the amplifier AMP2 is electrically connected to the negative phase terminal (the input terminal VinB3a illustrated in FIG. 5) of the input portion IN3a of the amplifier AMP3a via the transmission line electrode RL2. The ground terminal (the signal ground terminal SGND2 illustrated in FIG. 4) of the amplifier AMP2 is electrically connected to the ground terminal (the signal ground terminal SGND3a illustrated in FIG. 5) of the amplifier AMP3a via the electrode EP1.

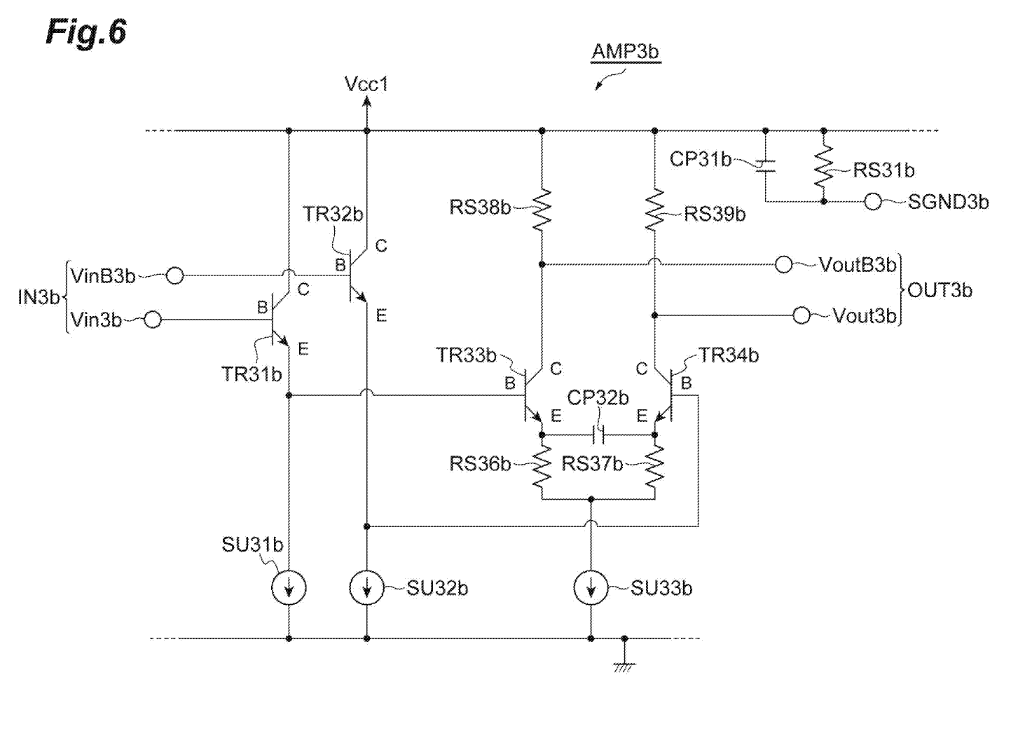

A positive phase terminal (an output terminal Vout3a illustrated in FIG. 5) of the output portion OUT3a of the amplifier AMP3a is electrically connected to a positive phase terminal (an input terminal Vin3b illustrated in FIG. 6) of the input portion IN3b of the amplifier AMP3b. A negative phase terminal (an output terminal VoutB3a illustrated in FIG. 5) of the output portion OUT3a of the amplifier AMP3a is electrically connected to a negative phase terminal (an input terminal VinB3b illustrated in FIG. 6) of the input portion IN3b of the amplifier AMP3b.

A positive phase terminal (an output terminal Vout3b illustrated in FIG. 6) of the output portion OUT3b of the amplifier AMP3b is electrically connected to the terminal TA3a, and the terminal TA3a is electrically connected (for example, bump-connected) to the terminal TB3a. The terminal TB3a is electrically connected to the input end IE3 of the transmission line electrode RL3. A negative phase terminal (an output terminal VoutB3b illustrated in FIG. 6) of the output portion OUT3b of the amplifier AMP3b is electrically connected to the terminal TA4a, and the terminal TA4a is electrically connected (for example, bump-connected) to the terminal TB4a. The terminal TB4a is electrically connected to the input end IE4 of the transmission line electrode RL4. A ground terminal (a signal ground terminal SGND3b illustrated in FIG. 6) of the amplifier AMP3b is electrically connected to the terminal TA6a, and the terminal TA6a is electrically connected (for example, bump-connected) to the terminal TB6a. The terminal TB6a is electrically connected to the electrode EP2.

The output end OE3 of the transmission line electrode RL3 is electrically connected to the terminal TB3b, and the terminal TB3b is electrically connected (for example, bump-connected) to the terminal TA3b. The terminal TA3b is electrically connected to the termination circuit TMC1. The output end OE4 of the transmission line electrode RL4 is electrically connected to the terminal TB4b, and the terminal TB4b is electrically connected (for example, bump-connected) to the terminal TA4b. The terminal TA4b is electrically connected to the termination circuit TMC1. The electrode EP2 is electrically connected to the terminal TB6b, and the terminal TB6b is electrically connected (for example, bump-connected) to the terminal TA6b.

The terminal TA6b is electrically connected to the termination circuit TMC1. The positive phase terminal (the output terminal Vout3b illustrated in FIG. 6) of the output portion OUT3b of the amplifier AMP3b is electrically connected to the termination circuit TMC1 via the transmission line electrode RL3. The negative phase terminal (the output terminal VoutB3b illustrated in FIG. 6) of the output portion OUT3b of the amplifier AMP3b is electrically connected to the termination circuit TMC1 via the transmission line electrode RL4. The ground terminal (the signal ground terminal SGND3b illustrated in FIG. 6) of the amplifier AMP3b is electrically connected to the termination circuit TMC1 via the electrode EP2.

The power supply circuit PSC1 is electrically connected to the amplifiers AMP1 to AMP3b. The power supply circuit PSC1 supplies a supply voltage and a supply current necessary for each amplifier to operate, to the amplifiers AMP1 to AMP3b. The power supply circuit PSC1 is electrically connected to the terminals TA7c to TA7e. The terminal TA7c is electrically connected (bump-connected) to the terminal TB7c. The terminal TA7d is electrically connected (bump-connected) to the terminal TB7d. The terminal TA7e is electrically connected (bump-connected) to the terminal TB7e.

The terminal TB7c is electrically connected to the electrode pad Pc. The terminal TB7d is electrically connected to the electrode pad Pd. The terminal TB7e is electrically connected to the electrode pad Pe. The electrode pads Pc to Pe can be electrically connected to an external power supply by wire bonding, for example. Note that, the power supply circuit PSC1 may include an active element such as a transistor, but may be include only wiring so that the supply voltage and the supply current can be supplied to the amplifiers AMP1 to AMP3b.

A voltage by a power supply Vcc1 illustrated in FIGS. 3 to 6 is applied from the electrode pad Pc to the amplifiers AMP1 to AMP3b via the power supply circuit PSC1. A voltage by a power supply Vcc2 illustrated in FIG. 5 is applied from the electrode pad Pd to the amplifier AMP3a via the power supply circuit PSC1. The power supply circuit PSC1 is grounded via the electrode pad Pe.

Next, with reference to FIGS. 3 to 6, the configurations of the amplifiers AMP1 to AMP3 will be described in more detail. FIG. 3 is a circuit diagram of the first stage amplifier of the electric circuit board illustrated in FIG. 1. The amplifier AMP1 according to the exemplary embodiment illustrated in FIG. 3 includes: the input terminals Vin1 and VinB1; the output terminals Vout1 and VoutB1; resistors RS11 to RS19; capacitors CP11 and CP12; transistors TR11 to TR14; and current sources SU11 to SU13.

The input terminal Vin1 is electrically connected to the control terminal (denoted by B in the figure, the same applies hereinafter) of the transistor TR11. The control terminal is, for example, the base of a bipolar transistor. The input terminal Vin1 is electrically connected to the power supply Vcc1 via the resistors RS11 (termination resistor) and RS13 in order. The resistors RS11 and RS13 are electrically connected in series in this order to the input terminal Vin1. The first current terminal (denoted by E in the figure, the same applies hereinafter) of the transistor TR11 is electrically connected to the control terminal of the transistor TR13.

The first current terminal, the first current terminal of the transistor TR11 that is, for example, the emitter of a bipolar transistor is grounded via the current source SU11 (electrically connected to a ground line for grounding). The second current terminal (denoted by C in the figure, the same applies hereinafter) of the transistor TR11 is electrically connected to the power supply Vcc1. The second current terminal is, for example, the collector of a bipolar transistor. Note that, the second current terminal of the transistor TR11 may be electrically connected to a power supply line for electrically connecting to the power supply Vcc1 instead of the power supply Vcc1. The transistor TR11 and the current source SU11 constitute an emitter follower as described later.

The input terminal VinB1 is electrically connected to the control terminal (base terminal) of the transistor TR12. The input terminal VinB1 is electrically connected to the power supply Vcc1 via the resistors RS12 (termination resistor) and RS13 in order. The resistors RS12 and RS13 are electrically connected in series in this order to the input terminal VinB1. The first current terminal (emitter terminal) of the transistor TR12 is electrically connected to the control terminal (base terminal) of the transistor TR14.

The first current terminal (emitter terminal) of the transistor TR12 is grounded (electrically connected to a ground line for grounding) via the current source SU12. The second current terminal (collector terminal) of the transistor TR12 is electrically connected to the power supply Vcc1. Note that, the second current terminal of the transistor TR12 may be electrically connected to a power supply line for electrically connecting to the power supply Vcc1 instead of the power supply Vcc1. The transistor TR12 and the current source SU12 constitute an emitter follower as described later.

The connection point between the resistors RS11 and RS13 (or the connection point between the resistors RS12 and RS13) is grounded (electrically connected to a ground line for grounding) via the resistor RS14. The connection point between the resistors RS11 and RS13 (or the connection point between the resistors RS12 and RS13) is grounded (electrically connected to a ground line for grounding) via the capacitor CP11.

That is, the resistor RS14 and the capacitor CP11 are electrically connected in parallel between the ground line and the connection point between the resistors RS11 and RS13 (or the connection point between the resistors RS12 and RS13). Here, the resistors RS13 and RS14 form a resistive voltage divider circuit. The connection point between the resistors RS13 and RS14 supplies a termination voltage (rs13/(rs13+rs14)×vcc1) to the resistors RS11 (termination resistor) and RS12 (rs13 represents a resistance value of the resistor RS13, rs14 represents a resistance value of the resistor RS14, and vcc1 represents a power supply voltage value of the power supply Vcc1). The capacitor CP11 can stabilize the termination voltage against noise.

The first current terminal (emitter terminal) of the transistor TR13 is electrically connected to the first current terminal (emitter terminal) of the transistor TR14 via the resistors RS16 and RS17. One terminal of the resistor RS16 is electrically connected to the transistor TR13, and the other terminal of the resistor RS16 is electrically connected to the resistor RS17. One terminal of the resistor RS17 is electrically connected to the transistor TR14, and the other terminal of the resistor RS17 is electrically connected to the resistor RS16. The connection point between the resistors RS16 and RS17 is grounded (or may be electrically connected to a ground line for grounding) via the current source SU13.

The second current terminal (collector terminal) of the transistor TR13 is electrically connected to the power supply Vcc1 (which may be a power supply line as described above) via the resistor RS18. The second current terminal (collector terminal) of the transistor TR14 is electrically connected to the power supply Vcc1 (which may be the power supply line as described above) via the resistor RS19. The first current terminal (emitter terminal) of the transistor TR13 is electrically connected to the first current terminal (emitter terminal) of the transistor TR14 via the capacitor CP12.

That is, between the first current terminal (emitter terminal) of the transistor TR13 and the first current terminal (emitter terminal) of the transistor TR14, the capacitor CP12 and a series circuit of the resistors RS16 and RS17 are electrically connected in parallel. For the transistors TR13 and TR14, transistors having the same structure and the same electrical characteristic are used.

The connection point between the resistor RS18 and the second current terminal (collector terminal) of the transistor TR13 is electrically connected to the output terminal VoutB1. The connection point between the resistor RS19 and the second current terminal (collector terminal) of the transistor TR14 is electrically connected to the output terminal Vout1.

In the exemplary embodiment, the resistors RS11 and RS12 each have a resistance value of about 50 [Ω], for example, and work as a termination resistor. For example, the resistance value of each of the resistors RS11 and RS12 may be set to a value of 25 [Ω] to 60 [Ω] to match a characteristic impedance of the transmission line electrically connected to a corresponding one of the electrode pads Pa and Pb. For example, a typical resistance value of each of the resistors RS11 and RS12 is 50 [Ω].

The transistor TR11 and the current source SU11, and the transistor TR12 and the current source SU12 constitute emitter follower circuits, respectively. The transistors TR13 and TR14, the resistors RS16 to RS19, the capacitor CP12, and the current source SU13 form a differential pair circuit. The current source SU13 works as a current source of the differential pair circuit.

The differential pair circuit and the current source SU13 form a differential amplifier circuit. When a constant current supplied by the current source SU13 is I1, the differential amplifier circuit divides the constant current I1 into a current (current value ic13) flowing through the resistor RS18 and a current (current value ic14) flowing through the resistor RS19, depending on a magnitude relationship between a voltage (base voltage value vb13) applied to the control terminal of the transistor TR13 and a voltage (base voltage value vb14) applied to the control terminal of the transistor TR14. For example, when vb13>vb14, ic13>ic14; when vb13<vb14, ic13<ic14; and when vb13=vb14, ic13=ic14. A voltage value (voltage signal) voutb1 of the output terminal VoutB1 is generated with reference to a power supply voltage value vcc1 of the power supply Vcc1, by a voltage drop when the current of the current value ic13 flows through the resistor RS18. That is, the voltage signal voutb1=vcc1−rs18×ic13 (rs18 represents a resistance value of the resistor RS18).

Similarly, a voltage value (voltage signal) vout1 of the output terminal Vout1 is generated with reference to the power supply voltage value vcc1 of the power supply Vcc1, by a voltage drop when the current of the current value ic14 flows through the resistor RS19. That is, the voltage signal vout1=vcc1−rs19×ic14 (rs19 represents the resistance value of the resistor RS19). Here, when the current (base current) flowing into the control terminal of the transistor TR13 and the current (base current) flowing into the control terminal of the transistor TR14 are ignored, it can be regarded as i1=ic13+ic14 (i1 represents a current value of the current I1). That is, when ic13 increases, the voltage value (voltage signal) voutb1 falls and ic14 decreases at this time, so that the voltage value (voltage signal) vout1 rises.

As described above, the voltage signals vout1 and voutb1 are complementary signals (first differential signals) whose phases are opposite to each other. The maximum value (maximum amplitude) of the amplitude of each of the voltage signals vout1 and voutb1 is RL×i1. Here, the resistance value RL represents a resistance value of each of the resistors RS18 and RS19. That is, the amplitude of the second differential signal increases or decreases depending on the current value i1 of the current I1 and the resistance value RL.

Linearity and a gain of the differential amplifier circuit vary depending on the resistors RS16 and RS17. When the resistance values of the resistors RS16 and RS17 are increased, the gain (differential voltage gain) decreases and a range (linear operation range) becomes wider in which the differential amplifier circuit operates linearly with respect to the base voltage values vb13 and vb14. Conversely, when the resistance values of the resistors RS16 and RS17 are decreased, the gain increases, and the range (linear operation range) becomes narrower in which the differential amplifier circuit operates linearly with respect to the base voltage values vb13 and vb14. The capacitor CP12 is used to adjust the gain of the differential amplifier circuit and frequency dependence of the linear operation range.

FIG. 4 is a circuit diagram of the second stage amplifier of the electric circuit board illustrated in FIG. 1. The amplifier AMP2 according to the exemplary embodiment illustrated in FIG. 4 includes: the input terminals Vin2 and VinB2; the output terminals Vout2 and VoutB2; the signal ground terminal SGND2; resistors RS21 and RS26 to RS29; capacitors CP21 and CP22; transistors TR21 to TR24; and current sources SU21 to SU23.

The input terminal Vin2 is electrically connected to the control terminal (base terminal) of the transistor TR21. The first current terminal (emitter terminal) of the transistor TR21 is electrically connected to the control terminal (base terminal) of the transistor TR23. The first current terminal (emitter terminal) of the transistor TR21 is grounded (or is electrically connected to a ground line for grounding) via the current source SU21. The second current terminal (collector terminal) of the transistor TR21 is electrically connected to the power supply Vcc1 (or may be electrically connected to a power supply line for electrically connecting to the power supply Vcc1).

The input terminal VinB2 is electrically connected to the control terminal (base terminal) of the transistor TR22. The first current terminal (emitter terminal) of the transistor TR22 is electrically connected to the control terminal (base terminal) of the transistor TR24. The first current terminal (emitter terminal) of the transistor TR22 is grounded (or is electrically connected to a ground line for grounding) via the current source SU22. The second current terminal (collector terminal) of the transistor TR22 is electrically connected to the power supply Vcc1 (or may be electrically connected to a power supply line for electrically connecting to the power supply Vcc1).

The first current terminal (emitter terminal) of the transistor TR23 is electrically connected to the first current terminal (emitter terminal) of the transistor TR24 via the resistors RS26 and RS27. One terminal of the resistor RS26 is electrically connected to the transistor TR23, and the other terminal of the resistor RS26 is electrically connected to the resistor RS27. One terminal of the resistor RS27 is electrically connected to the transistor TR24, and the other terminal of the resistor RS27 is electrically connected to the resistor RS26. The connection point between the resistors RS26 and RS27 is grounded (or may be electrically connected to a ground line for grounding) via the current source SU23.

The second current terminal (collector terminal) of the transistor TR23 is electrically connected to the power supply Vcc1 (or a power supply line) via the resistor RS28. The second current terminal (collector terminal) of the transistor TR24 is electrically connected to the power supply Vcc1 (or a power supply line) via the resistor RS29. The first current terminal (emitter terminal) of the transistor TR23 is electrically connected to the first current terminal (emitter terminal) of the transistor TR24 via the capacitor CP22.

That is, between the first current terminal (emitter terminal) of the transistor TR23 and the first current terminal (emitter terminal) of the transistor TR24, the capacitor CP22 and a series circuit of the resistors RS26 and RS27 are electrically connected in parallel. For the transistors TR23 and TR24, transistors having the same structure and the same electrical characteristic are used.

The connection point between the resistor RS28 and the second current terminal (collector terminal) of the transistor TR23 is electrically connected to the output terminal VoutB2. The connection point between the resistor RS29 and the second current terminal (collector terminal) of the transistor TR24 is electrically connected to the output terminal Vout2.

The signal ground terminal SGND2 is electrically connected to the power supply Vcc1 (or may be electrically connected to a power supply line for electrically connecting to the power supply Vcc1) via the capacitor CP21. The signal ground terminal SGND2 is electrically connected to the power supply Vcc1 (or may be electrically connected to a power supply line for electrically connecting to the power supply Vcc1) via the resistor RS21. Therefore, the capacitor CP21 and the resistor RS21 are electrically connected in parallel between the signal ground terminal SGND2 and the power supply Vcc1 (or a power supply line).

In the exemplary embodiment, the amplifier AMP2 functions as a driver circuit of the transmission line portion RLa (first transmission line portion). The transistor TR21 and the current source SU21, and the transistor TR22 and the current source SU22 constitute emitter follower circuits, respectively. Transistors TR23 and TR24, the resistors RS26, RS27, RS28, and RS29, and the capacitor CP22 constitute a differential pair circuit. The current source SU23 functions as a current source of the differential pair circuit.

The differential pair circuit and the current source SU23 constitute a differential amplifier circuit. The differential amplifier circuit amplifies the first differential signal received via the input portion IN2 (input terminals Vin2 and VinB2) and the emitter follower circuit including the transistors TR21 and TR22, and outputs the first differential signal amplified as the second differential signal from the output portion OUT2 (output terminals Vout2 and VoutB2). The amplifier AMP2 does not include a termination resistor at the input portion IN2. Since the amplifier AMP2 is arranged close to the amplifier AMP1, it is possible to propagate an output differential signal output from the amplifier AMP1 to the amplifier AMP2 without intervention of the transmission line. For that reason, the input portion IN2 does not have to include a termination resistor which is used for impedance matching. The configuration and operation of the differential amplifier circuit of the amplifier AMP2 are substantially the same as the configuration and operation of the differential amplifier circuit of the amplifier AMP1 described above, and a description thereof is omitted.

The current source SU23 supplies a constant current of about 20 [mA] to 200 [mA], for example. The resistors RS28 and RS29 each have a resistance value of, for example, about 20 [Ω] to 200 [Ω]. The resistor RS21 and the capacitor CP21 are elements forming a signal ground (GND). The resistor RS21 is of, for example, about 1 [kΩ]. The capacitor CP21 is of, for example, about 10 [pF]. An impedance of the capacitor CP21 at this time is about 16 [Ω] at a frequency of 1 [GHz].

FIG. 5 is a circuit diagram of the third stage amplifier of the electric circuit board illustrated in FIG. 1. The amplifier AMP3a according to the exemplary embodiment illustrated in FIG. 5 includes: the input terminals Vin3a and VinB3a; the output terminals Vout3a and VoutB3a; the signal ground terminal SGND3a; resistors RS31a to RS39a; capacitors CP31a and CP32a; transistors TR31a to TR34a; and current sources SU31a to SU33a.

The input terminal Vin3a is electrically connected to the control terminal (base terminal) of the transistor TR31a via the resistor RS31a. The input terminal Vin3a is electrically connected to the power supply Vcc1 (or electrically connected to a power supply line for electrically connecting to the power supply Vcc1) via the resistors RS31a and RS33a in order. The resistors RS31a and RS33a are electrically connected in series in this order to the input terminal Vin3a. The first current terminal (emitter terminal) of the transistor TR31a is electrically connected to the control terminal (base terminal) of the transistor TR33a.

The first current terminal (emitter terminal) of the transistor TR31a is grounded (or is electrically connected to a ground line for grounding) via the current source SU31a. The second current terminal (collector terminal) of the transistor TR31a is electrically connected to the power supply Vcc1 (or may be electrically connected to electrically connected to a power supply line for electrically connecting to the power supply Vcc1).

The input terminal VinB3a is electrically connected to the control terminal (base terminal) of the transistor TR32a via the resistor RS32a. The input terminal VinB3a is electrically connected to the power supply Vcc1 (or electrically connected to a power supply line for electrically connecting to the power supply Vcc1) via the resistors RS32a and RS34a in order. The resistors RS32a and RS34a are electrically connected in series in this order to the input terminal VinB3a. The first current terminal (emitter terminal) of the transistor TR32a is electrically connected to the control terminal (base terminal) of the transistor TR34a.

The first current terminal (emitter terminal) of the transistor TR32a is grounded (or is electrically connected to a ground line for grounding) via the current source SU32a. The second current terminal (collector terminal) of the transistor TR32a is electrically connected to the power supply Vcc1 (or may be electrically connected to a power supply line for electrically connecting to the power supply Vcc1).

The signal ground terminal SGND3a is electrically connected to the power supply Vcc1 (or may be electrically connected to a power supply line for electrically connecting to the power supply Vcc1) via the resistor RS35a. The signal ground terminal SGND3a is electrically connected to the power supply Vcc1 (or may be electrically connected to a power supply line for electrically connecting to the power supply Vcc1) via the capacitor CP31a. The resistor RS35a and the capacitor CP31a are electrically connected in parallel between the signal ground terminal SGND3a and the power supply Vcc1 (or a power supply line).

The first current terminal (emitter terminal) of the transistor TR33a is electrically connected to the first current terminal (emitter terminal) of the transistor TR34a via the resistors RS36a and RS37a. One terminal of the resistor RS36a is electrically connected to the transistor TR33a, and the other terminal of the resistor RS36a is electrically connected to the resistor RS37a. One terminal of the resistor RS37a is electrically connected to the transistor TR34a, and the other terminal of the resistor RS37a is electrically connected to the resistor RS36a. The connection point between the resistors RS36a and RS37a is grounded (or may be electrically connected to a ground line for grounding) via the current source SU33a.

The second current terminal (collector terminal) of the transistor TR33a is electrically connected to the power supply Vcc2 (or a power supply line for electrically connecting to the power supply Vcc2) via the resistor RS38a. The second current terminal (collector terminal) of the transistor TR34a is electrically connected to the power supply Vcc2 (or a power supply line for electrically connecting to the power supply Vcc2) via the resistor RS39a.

The first current terminal (emitter terminal) of the transistor TR33a is electrically connected to the first current terminal (emitter terminal) of the transistor TR34a via the capacitor CP32a. That is, between the first current terminal (emitter terminal) of the transistor TR33a and the first current terminal (emitter terminal) of the transistor TR34a, the capacitor CP32a and a series circuit of the resistors RS36a and RS37a are electrically connected in parallel. For the transistors TR33a and TR34a, transistors having the same structure and the same electrical characteristic are used.

The connection point between the resistor RS38a and the second current terminal (collector terminal) of the transistor TR33a is electrically connected to the output terminal VoutB3a. The connection point between the resistor RS39a and the second current terminal (collector terminal) of the transistor TR34a is electrically connected to the output terminal Vout3a.

As described above, the amplifier AMP3a amplifies the second differential signal output from the transmission line portion RLa, and inputs the amplified second differential signal as the third differential signal to the transmission line portion RLb via the amplifier AMP3b. The amplifier AMP3a includes: a pair of first transistors (transistors TR33a and TR34a) each including the control terminal, the first current terminal, and the second current terminal; a first resistor (resistor RS36a); a second resistor (Resistor RS37a); and a first capacitor (capacitor CP32a), in which the first capacitor and a series circuit in which the first resistor and the second resistor are electrically connected in series are electrically connected in parallel between the first current terminal of one of the pair of first transistors and the first current terminal of the other of the pair of first transistors, and the second differential signal is input to the control terminal of one of the pair of the first transistors and the control terminal of the other of the pair of the first transistors.

In the exemplary embodiment, a parallel circuit of the resistor RS35a and the capacitor CP31a constitute a signal GND node (signal ground terminal SGND3a). The resistor RS35a has a resistance value of, for example, about 200 [Ω]. The capacitor CP31a has a capacitance value of, for example, about 10 [pF]. Due to the parallel connection of the resistor RS35a and the capacitor CP31a, an impedance with respect to GND of the signal GND node is, for example, a relatively low impedance (for example, less than or equal to 20 [Ω]) for a signal frequency higher than or equal to 1 [GHz], and is a relatively high resistance value (for example, about 200 [Ω]) for a signal frequency from a direct current (DC) to a low frequency. Here, in a high frequency circuit, it is considered that the power supply can be regarded as equivalent to GND for considering circuit operation. Therefore, a DC potential of GND of the transmission line portion RLa can be set to a desired value.

A sum of a resistance value of the resistor RS31a and a resistance value of the resistor RS33a is set to the same value as a characteristic impedance of the transmission line portion RLa. That is, a series circuit of the resistors RS31a and RS33a works as a termination resistor. A value (quotient) obtained by dividing the resistance value of the resistor RS33a by the sum of the resistance value of the resistor RS33a and the resistance value of the resistor RS31a represents an attenuation ratio of a signal at the input terminal Vin3a. A value (quotient) obtained by dividing a resistance value of the resistor RS34a by a sum of a resistance value of the resistor RS34a and a resistance value of the resistor RS32a represents an attenuation ratio of a signal at the input terminal VinB3a.

Signals input to the input terminals Vin3a and VinB3a are attenuated in amplitude by the resistors RS31a to RS34a, and are input to the transistors TR33a and TR34a of the differential pair circuit, respectively. The transistor TR31a and the current source SU31a, the transistor TR32a and the current source SU32a constitute emitter follower circuits, respectively. The transistors TR33a and TR34a, the resistors RS36a to RS39a, and the capacitor CP32a constitute a differential pair circuit. The current source SU33a works as a current source of the differential pair circuit.

The differential pair circuit and the current source SU33a constitute a differential amplifier circuit. The differential amplifier circuit amplifies the second differential signal received via the input portion IN3a (input terminals Vin3a and VinB3a) and the emitter follower circuit including the transistors TR31a and TR32a, and outputs the amplified second differential signal from the output portion OUT3a (output terminals Vout3a and VoutB3a). The configuration and operation of the differential amplifier circuit of the amplifier AMP3a are substantially the same as the configuration and operation of the differential amplifier circuit of the amplifier AMP1 described above, except for the difference in power supply, and a description thereof is omitted. Note that, in the differential amplifier circuit, by changing the capacitor CP32a, it is possible to adjust the gain of the differential amplifier circuit and the frequency dependence (equalizer peaking characteristic) of the linear operation range.

FIG. 6 is a circuit diagram of the fourth stage amplifier of the electric circuit board illustrated in FIG. 1. The amplifier AMP3b according to the exemplary embodiment illustrated in FIG. 6 includes: the input terminals Vin3b and VinB3b; the output terminals Vout3b and VoutB3b; the signal ground terminal SGND3b; resistors RS31b and RS36b to RS39b; capacitors CP31b and CP32b; transistors TR31b to TR34b; and current sources SU31b to SU33b.

The input terminal Vin3b is electrically connected to the control terminal (base terminal) of the transistor TR31b. The first current terminal (emitter terminal) of the transistor TR31b is electrically connected to the control terminal (base terminal) of the transistor TR33b. The first current terminal (emitter terminal) of the transistor TR31b is grounded (or is electrically connected to a ground line for grounding) via the current source SU31b. The second current terminal (collector terminal) of the transistor TR31b is electrically connected to the power supply Vcc1 (or may be electrically connected to a power supply line for electrically connecting to the power supply Vcc1).

The input terminal VinB3b is electrically connected to the control terminal (base terminal) of the transistor TR32b. The first current terminal (emitter terminal) of the transistor TR32b is electrically connected to the control terminal (base terminal) of the transistor TR34b. The first current terminal (emitter terminal) of the transistor TR32b is grounded (or is electrically connected to a ground line for grounding) via the current source SU32b. The second current terminal (collector terminal) of the transistor TR32b is electrically connected to the power supply Vcc1 (or may be electrically connected to a power supply line for electrically connecting to the power supply Vcc1).

The first current terminal (emitter terminal) of the transistor TR33b is electrically connected to the first current terminal (emitter terminal) of the transistor TR34b via the resistors RS36b and RS37b. One terminal of the resistor RS36b is electrically connected to the transistor TR33b, and the other terminal of the resistor RS36b is electrically connected to the resistor RS37b.

One terminal of the resistor RS37b is electrically connected to the transistor TR34b, and the other terminal of the resistor RS37b is electrically connected to the resistor RS36b. The connection point between the resistor RS36b and the resistor RS37b is grounded (or may be electrically connected to a ground line for grounding) via the current source SU33b.

The second current terminal (collector terminal) of the transistor TR33b is electrically connected to the power supply Vcc1 (or a power supply line) via the resistor RS38b. The second current terminal (collector terminal) of the transistor TR34b is electrically connected to the power supply Vcc1 (or a power supply line) via the resistor RS39b. The first current terminal (emitter terminal) of the transistor TR33b is electrically connected to the first current terminal (emitter terminal) of the transistor TR34b via the capacitor CP32b.

That is, between the first current terminal (emitter terminal) of the transistor TR33b and the first current terminal (emitter terminal) of the transistor TR34b, the capacitor CP32b and a series circuit of the resistors RS36b and RS37b are electrically connected in parallel. For the transistors TR33b and TR34b, transistors having the same structure and the same electrical characteristic are used.

The connection point between the resistor RS38b and the second current terminal (collector terminal) of the transistor TR33b is electrically connected to the output terminal VoutB3b. The connection point between the resistor RS39b and the second current terminal (collector terminal) of the transistor TR34b is electrically connected to the output terminal Vout3b.

The signal ground terminal SGND3b is electrically connected to the power supply Vcc1 (or may be electrically connected to a power supply line for electrically connecting to the power supply Vcc1) via the capacitor CP31b. The signal ground terminal SGND3b is electrically connected to the power supply Vcc1 (or may be electrically connected to a power supply line for electrically connecting to the power supply Vcc1) via the resistor RS31b. The capacitor CP31b and the resistor RS31b are electrically connected in parallel between the signal ground terminal SGND3b and the power supply Vcc1 (or a power supply line).

In the exemplary embodiment, the amplifier AMP3b works as a driver circuit of the transmission line portion RLb (second transmission line portion). The transistor TR31b and the current source SU31b, and the transistor TR32b and the current source SU32b constitute emitter follower circuits, respectively. The transistors TR33b and TR34b, the resistors RS36b to RS39b, and the capacitor CP32b form constitute a differential pair circuit. The current source SU33b works as a current source of the differential pair circuit.

The differential pair circuit and the current source SU33b constitute a differential amplifier circuit. The differential amplifier circuit receives the third differential signal amplified and output by the amplifier AMP3a via the input portion IN3b (input terminals Vin3b and VinB3b) and the emitter follower circuit including the transistors TR31b and TR32b, and further amplifies the third differential signal received, and outputs the amplified third differential signal further from the output portion OUT3b (output terminals Vout3b and VoutB3b). The configuration and basic operation of the differential amplifier circuit of the amplifier AMP3b are substantially the same as the configuration and basic operation of the differential amplifier circuit of the amplifier AMP2 described above, and a description thereof is omitted.

The current source SU33b supplies a constant current (DC current) of, for example, about 20 [mA] to 200 [mA]. The resistors RS38b and RS39b each have a resistance value of, for example, about 20 [Ω] to 200 [Ω]. The resistor RS31b and the capacitor CP31b form a signal GND. The resistor RS31b is of, for example, about 1 [kΩ]. The capacitor CP31b is of, for example, about 10 [pF].

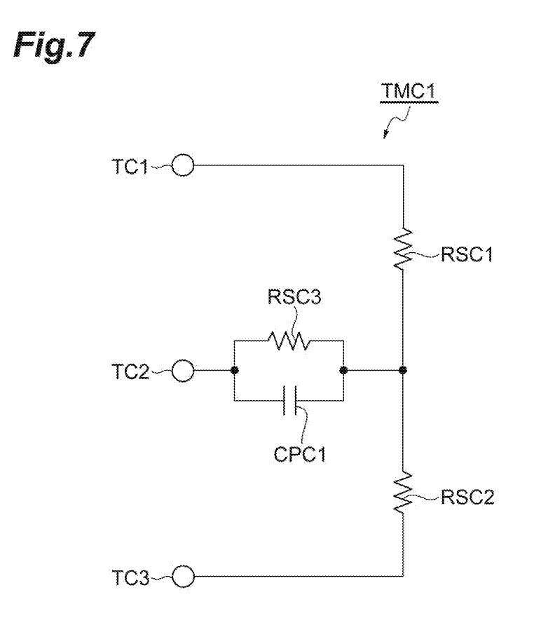

FIG. 7 is a circuit diagram of a termination circuit of the electric circuit board illustrated in FIG. 1. The termination circuit TMC1 according to the exemplary embodiment illustrated in FIG. 7 includes: terminals TC1 to TC3; resistors RSC1 to RSC3; and a capacitor CPC1. The terminal TC1 is electrically connected to the terminal TA3b, the terminal TC2 is electrically connected to the terminal TA6b, and the terminal TC3 is electrically connected to the terminal TA4b (see FIG. 1). The terminal TC1 is electrically connected to the terminal TC3 via the resistors RSC1 and RSC2 in order. The resistors RSC1 and RSC2 are electrically connected in series between the terminals TC1 and TC3. The connection point between the resistors RSC1 and RSC2 is electrically connected to the terminal TC2 via the resistor RSC3. The connection point between the resistors RSC1 and RSC2 is electrically connected to the terminal TC2 via the capacitor CPC1. The capacitor CPC1 and the resistor RSC3 are electrically connected in parallel between the terminal TC2 and the connection point between the resistors RSC1 and RSC2.

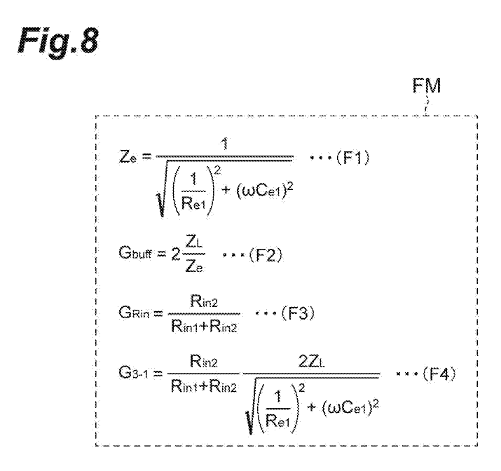

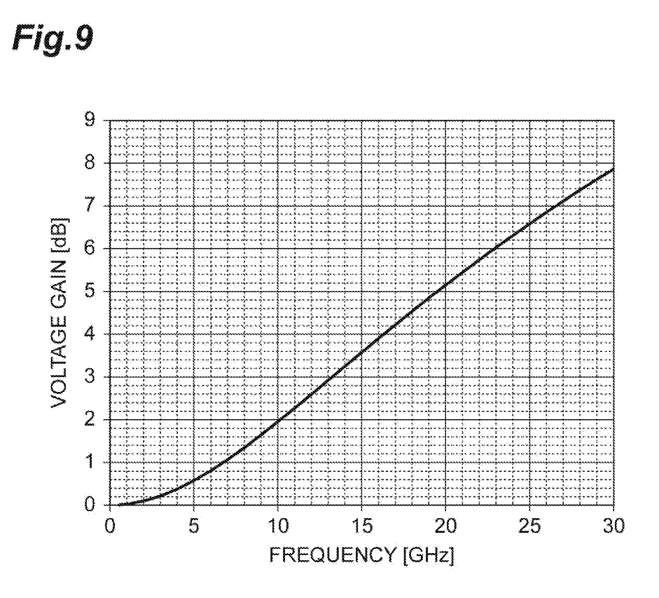

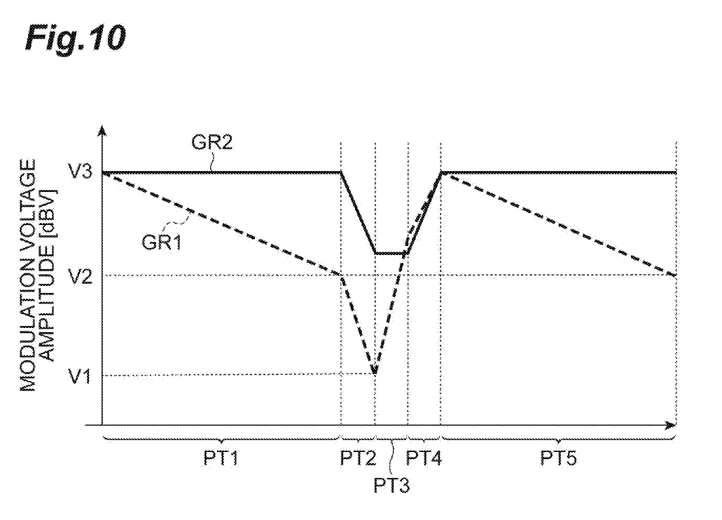

Next, with reference to FIGS. 5, and 8 to 10, an effect (advantage) will be exemplarily described of the optical modulation apparatus 1 according to the exemplary embodiment of the present invention. FIG. 8 is a formula group (formula group FM) for explaining operation of the third stage amplifier (amplifier AMP3a) illustrated in FIG. 5. FIG. 9 is a diagram illustrating a frequency characteristic of a voltage gain of the third stage amplifier illustrated in FIG. 5. FIG. 10 is a diagram illustrating a state of change of an amplitude (peak-to-peak value) of a signal flowing through the electric circuit of the optical modulation apparatus according to the exemplary embodiment of the present invention.

A description will be made with reference to FIGS. 5, 8 and 9. A formula F1 indicates a value Ze of an impedance of the RC circuit electrically connected to the emitter terminal of the transistor TR33a (or TR34a) of the differential pair circuit including the transistors TR33a and TR34a (in the following description, referred to as a differential pair circuit DF for convenience). In the formula F1, Re1 is a resistance value of the resistor RS36a (or RS37a). In the formula F1, Ce1 is a value twice a capacitance value of the capacitor CP32a. In the formula F1, ω is an angular frequency of a signal (2π×f; f is a frequency [GHz]). In addition, a formula F2 indicates a voltage gain Gbuff of the differential pair circuit DF. In the formula F2, ZL is a value of a load impedance of the differential pair circuit DF, and is a resistance value of the resistor RS38a (or RS39a). Note that, usually, the resistance value of the resistor RS38a is set to the same value as the resistance value of the resistor RS39a.

In the formula F2, Ze represents the impedance value of the RC circuit of the differential pair circuit DF described above. In addition, a formula F3 indicates a gain GRin (attenuation amount) of an attenuator portion (the resistors RS31a to RS34a) of the amplifier AMP3a. In the formula F3, Rin1 represents the resistance value of the resistor RS31a (or RS32a). In the formula F3, Rin2 represents the resistance value of the resistor RS33a (or RS34a). A formula F4 indicates a voltage gain G3-1 from the input terminals Vin3a and VinB3a to the output terminals Vout3a and VoutB3a. The voltage gain G3-1 becomes equal to a product of Gbuff and GRin as illustrated in the formula F4.

FIG. 9 illustrates an example of the frequency characteristic of the voltage gain G3-1 indicated in the formula F4. FIG. 9 illustrates a result obtained in a case where Rin1=0 [Ω], Rin2=50 [Ω], Re1=40 [Ω], Ce1=0.300 [fF], and ZL=40 [Ω]. The horizontal axis in FIG. 9 is a frequency [GHz] of a signal, and is a value (quotient) obtained by dividing co indicated in the formula F4 by 2π. The vertical axis in FIG. 9 is the voltage gain G3-1 [dB] indicated in the formula F4. As illustrated in FIG. 9, the voltage gain (differential voltage gain) of the amplifier AMP3a monotonously increases as the frequency of the input differential signal increases. That is, a voltage gain (maximum value) of a certain frequency region (first frequency region) is smaller than a voltage gain (minimum value) of a frequency region (second frequency region) higher in frequency than the first frequency region.

Next, a description will be made with reference to FIG. 10. The horizontal axis of FIG. 10 indicates a position (location) on a transmission path of a modulation signal of the electric circuit board BP1a, and the vertical axis of FIG. 10 indicates an amplitude (modulation voltage amplitude) [dBV] of the modulation signal flowing through the electric circuit board BP1a. This amplitude corresponds to a peak-to-peak value of a signal waveform. A section PT1 corresponds to the transmission line portion RLa. A section PT2 corresponds to the attenuator portion (resistors RS31a to RS34a) of the amplifier AMP3a. A section PT3 corresponds to the emitter follower circuit and differential pair buffer of the amplifier AMP3a. A section PT4 corresponds to the amplifier AMP3b.

A section PT5 corresponds to the transmission line portion RLb. A polygonal line GR1 represents a result by a sinusoidal signal of 30 [GHz] (for convenience of description, referred to as a high frequency signal), and a polygonal line GR2 represents a result by a sinusoidal signal of 1 [GHz] (for convenience of description, referred to as a low frequency signal). The polygonal line GR2 is considered to be similar for a sinusoidal signal of a frequency lower than 1 [GHz], for example, 1 [MHz].

Even when the low frequency signal (polygonal line GR2) propagates through the transmission line portion RLa in the section PT1, as for the voltage amplitude of the low frequency signal (polygonal line GR2), a voltage amplitude value V3 at the time of input to the transmission line portion RLa is maintained until output from the transmission line portion RLa. On the other hand, as for the high frequency signal (polygonal line GR1), the voltage amplitude attenuates from the voltage amplitude value V3 to a voltage amplitude value V2 smaller than the voltage amplitude value V3, by propagating through the transmission line portion RLa. In the section PT2, the voltage amplitudes of the high frequency signal (polygonal line GR1) and the low frequency signal (polygonal line GR2) both decrease by the attenuation effect of the attenuator portion (input resistance) of the amplifier AMP3a, and the voltage amplitude of the high frequency signal (polygonal line GR1) decreases from the voltage amplitude value V2 to a voltage amplitude value V1 smaller than the voltage amplitude value V2. Note that, in this example, a situation has been assumed in which the attenuation amount of the attenuator portion of the amplifier AMP3a is larger than 0 [dB] by setting, for example, Rin1=30 [Ω] and Rin2=20 [Ω].

In the section PT3, even when the low frequency signal (polygonal line GR2) passes through the amplifier AMP3a, the voltage amplitude does not increase too much. On the other hand, the high frequency signal (polygonal line GR1) is amplified by the amplifier AMP3a, and its voltage amplitude is larger than the voltage amplitude of the low frequency signal, at the output portion OUT3a of the amplifier AMP3a. This is because, as illustrated in FIG. 9, the gain of the amplifier AMP3a is set to be small for the low frequency signal and to be large for the high frequency signal. Therefore, a setting is made such that equalizing is performed to suppress a change (variation) in the modulation voltage amplitude with respect to the frequency by amplifying the high frequency signal having a large amount of attenuation in the transmission line portion RLa more than the low frequency signal having a small attenuation amount in the transmission line portion RLa, at the output portion OUT3a of the amplifier AMP3a.

In the section PT4, both the high frequency signal (polygonal line GR1) and the low frequency signal (polygonal line GR2) are amplified to the voltage amplitude value V3 by the amplifier AMP3b and output. Equalizing is also performed here by the amplifier AMP3b similarly to the amplifier AMP3a. In the section PT5, the high frequency signal (polygonal line GR1) decreases from the voltage amplitude value V3 to the voltage amplitude value V2 similarly to the transmission line portion RLa (section PT1) by propagating through the transmission line portion RLb.

In the optical modulation apparatus 1 according to the exemplary embodiment, to suppress attenuation of the high frequency component of the differential modulation signal by the transmission line electrode (transmission line portion), (a) the transmission line electrode is divided into a front portion (transmission line portion RLa) and a rear portion (transmission line portion RLb), (b) the differential modulation signal that is amplified by the amplifier AMP2 and then input to the transmission line portion RLa of the front stage and output from the transmission line portion RLa, is amplified by the amplifier AMP3 (particularly the amplifier AMP3a) in which the gain of the high frequency component of the differential modulation signal is set larger than the gain of the low frequency component, and is input to the transmission line portion RLb of the rear portion.

Note that, when the differential modulation signal is amplified by the amplifier AMP3, a delay occurs in the differential modulation signal modulated in the rear portion (the transmission line portion RLb) by the delay time of the amplifier AMP3. The length of the optical waveguide portion LW1 in the second region FD2 (optical delay portion) is set to be longer (for example, the optical waveguides LW1a and LW1b are formed to protrude to the outside) to delay the optical signal to offset the delay. Therefore, without adjusting the input timing of the differential modulation signal to the transmission line portion RLa of the front portion and the input timing of the differential modulation signal to the transmission line portion RLb of the rear portion by using a delay circuit or the like, attenuation is compensated of the high frequency component of the differential modulation signal that can occur in the transmission line portion RLa of the front portion. In addition, since no delay circuit is used, an increase is avoided in the area of the electric circuit board BP1a by the delay circuit.

While the principle of the invention has been illustrated and described in the preferred exemplary embodiment, it will be appreciated by those skilled in the art that the present invention may be modified in arrangement and detail without departing from such principle. The present invention is not limited to the specific configuration disclosed in this exemplary embodiment. Accordingly, all modifications and changes within the scope of the claims and the spirit thereof are claimed.

What is claimed is:

1. An optical modulation apparatus configured to modulate an optical signal in response to a differential input signal, the optical modulation apparatus comprising:
an electric circuit including:
an input circuit configured to generate a first differential signal in response to the differential input signal;
a first amplifier configured to amplify the first differential signal, and output an amplified first differential signal as a second differential signal;
a first transmission line portion configured to propagate the second differential signal;
a second amplifier configured to amplify the second differential signal propagated through the first transmission line portion, and output an amplified second differential signal as a third differential signal; a second transmission line portion configured to propagate the third differential signal; and
a termination circuit configured to terminate the the third differential signal propagated through the second transmission line portion; and
an optical modulator including:
a first optical modulation portion configured to modulate a phase of the optical signal in response to the second differential signal propagating through the first transmission line portion;
an optical delay portion configured to delay the phase of the optical signal modulated by the first optical modulation portion by a first delay time; and
a second optical modulation portion configured to modulate the phase of the optical signal modulated by the first optical modulation portion and delayed by the optical delay portion, in response to the third differential signal propagating through the second transmission line portion,
wherein the second amplifier has a gain that has a maximum value in a first frequency region of the second differential signal set to be smaller than a minimum value in a second frequency region higher in frequency than the first frequency region.

2. The optical modulation apparatus according to claim 1, wherein
the optical delay portion has a propagation length set to match the first delay time to a second delay time from a first time when the second differential signal is input to the second amplifier to a second time when the third differential signal is output from the second amplifier.

3. The optical modulation apparatus according to claim 1, wherein
the second amplifier
includes: a pair of first transistors each including a control terminal, a first current terminal, and a second current terminal; a first resistor; a second resistor; and a first capacitor, wherein the first capacitor and a series circuit in which the first resistor and the second resistor are connected in series are connected in parallel between the first current terminal of one of the pair of first transistors and the first current terminal of another of the pair of first transistors, and the second differential signal is input to the control terminal of the one of the pair of first transistors and the control terminal of the other of the pair of first transistors.

4. The optical modulation apparatus according to claim 1, further comprising an electric circuit boad and an optical waveguide board,
wherein the input circuit, the first amplifier, the second amplifier, and the termination circuit are formed on the electric circuit boad,
wherein the first optical modulation portion, the optical delay portion, and the second transmission line portion are formed on the optical waveguide board,
wherein the first transmission line portion is included in the first optical modulation portion, and the second transmission line portion is included in the second optical modulation portion,
wherein the first transmission line portion is electrically connected between the first amplifier and the second amplifier, and the the second transmission line portion is electrically connected between the second amplifier and the termination circuit.
